(19) United States
(12) Patent Application Publication
(10) Pub. No.: US 2008/0006160 A1
(43) Pub. Date: Jan. 10, 2008

(54) THE CAN CRUSHER

(76) Inventors: Hanan M. Al-Awadhi, Kuwait City (KW); Mohammed Al-Essa, Kuwait City (KW); Ahmed Al-Jama'an, Kuwait City (KW); Abdulwahab Al-Qabandi, Kuwait City (KW)

Correspondence Address: FURR LAW FIRM, 2622 DEBOLT ROAD, UTICA, OH, 43080, US

(21) Appl. No.: 11/456,378

(22) Filed: Jul. 10, 2006

(51) Int. Cl. B30B 1/00

(52) U.S. Cl. 100/280; 100/902; 100/266

(57) ABSTRACT

The present invention relates to a device that is capable of crushing paper and aluminum and steel cans. The machine is assembled using the following components: hydraulic bottle jack, extension springs, single-phase geared motor, sliding contact mechanism, and pressure gauge. The input system consists of two major parts, the driving system and the sliding contact mechanism. The driving system is an electric motor with a gearbox. This geared motor is single-phased so it can be utilized in residences and restaurants. The sliding contact is divided to three main parts: the crank, slider and lever. The hydraulic jack is a lifting device that uses liquid-oil to raise heavy objects, but in this case its objective is to crush the cans while being raised. The frame is divided into four main parts: container, vertical frame, lower plate and upper plate.

### BACKGROUND OF INVENTION

The present invention relates to a device that is capable of crushing paper, aluminum and steel cans.

### BACKGROUND

The world is currently producing large volumes of trash. It is desirable to condense or crush some types of trash to reduce the space requirement as well as prepare some of it for recycling. Solid waste reduction means that the world becomes more environmentally friendly.

Aluminum cans are the real success story of the recycling movement. By far, the most valuable component in the consumer waste stream, they enjoy the greatest public recognition as a recycled household item. With historical values from $0.35 to $0.75 per pound, aluminum cans are often the economic backbone of municipal and private recycling programs. Aluminum can scrap has always had a strong price in comparison to other recyclables. Aluminum cans are collected in a variety of ways. In most developed countries, cans are returned through deposit schemes. With these systems you pay a deposit or fee when you purchase a full container. When the container is empty, you return it to a designated collection site and your fee is refunded. This collection method is very effective but the cost usually exceeds the recycling value for the containers. Buy-back collection mechanisms are still very popular in many parts of the western hemisphere. People are offered money for aluminum that they collect and redeem at a recycling center or reverse vending machine. Most locations buy the cans by weight, but some of the older systems pay for each can. Voluntary drop off locations are still in use in much of the EU and in more rural parts of the US. Many of these programs have been replaced by blue box programs where a number of household recyclables are backed up at the curb and taken to large recycling facilities that sort and package the items for sale. Recyclers can process aluminum cans in a number of ways. Small, low volume processors will normally flatten cans and sell them to a near by wholesaler, larger operations will bail, and in some cases shred cans for shipment to aluminum consumers. The aluminum companies have defined specifications on how aluminum cans should be prepared.

During the last ten years the steel can manufacturing industry has been aggressively addressing the recyclables of all of the many different types of steel cans. Thanks to their efforts, steel can recycling rates have quickly risen across the western world. Because of steel's unique magnetic properties, collection of steel cans is relatively simple, relieving the consumer of much of the burden of separation in many geographic regions where magnetic separation is utilized. In 1996, nearly 19 billion steel cans were re-melted into new products. Steel can recycling rates have increased from 15 percent in 1988 to an astounding 58.2 percent in 1997, resulting in a diversion of 1.6 million tons of steel from landfills. More than 28 percent of a new steel can is made from recycled steel. Aluminum cans were recycled at a rate of 63.5 percent. After collection and processing, the aluminum UBC (Used Beverage Cans) are shipped by truck, railcar or sea container to smelting plants. The bales of cans are unloaded and tested for quality and moisture content. After inspection, the bales of cans are broken up in a shredder into small pieces. These shredded cans are then conveyed into a De-lacquering oven to remove the paint and residual moisture. The hot shredded aluminum is then passed over a small screen to remove dirt and contaminants and fed directly into a reverbatory furnace.

### SUMMARY OF INVENTION

The present invention relates to a device that is capable of crushing paper, aluminum and steel cans. The machine is assembled using the following components: hydraulic bottle jack, extension springs, single-phase geared motor, sliding contact mechanism, and pressure gauge. The input system consists of two major parts, the driving system and the sliding contact mechanism. The driving system is an electric motor with a gearbox. This geared motor is single-phased so it can be utilized in residences and restaurants. The sliding contact is divided to three main parts: the crank, slider and lever. The hydraulic jack is a lifting device that uses liquid-oil to raise heavy objects, but in this case its objective is to crush the cans while being raised. The frame is divided into four main parts: container, vertical frame, lower plate and upper plate.

The device is part of a new initiative on how to reduce the capacity of waste and recycle it in our daily lives. It is a new device that can reduce the size of paper, cans (both steel & aluminum) and compost.

When tested, the “Can Crusher” device fulfils its objectives. Results show that aluminum cans, for instance, are reduced to 95% of their original volume, while steel cans are reduced to around 90%.

### BRIEF DESCRIPTION OF DRAWINGS

Without restricting the full scope of this invention, the preferred form of this invention is illustrated in the following drawings:

FIG. 1 shows the main components of the invention;

FIG. 2 shows the sliding contact mechanism;

FIG. 3 shows the base and frame;

FIG. 4 shows the extension springs;

FIG. 5 shows the container;

FIG. 6 shows the upper plate cover;

FIG. 7 shows the lower plate cover; and

FIG. 8 displays the device in operation.

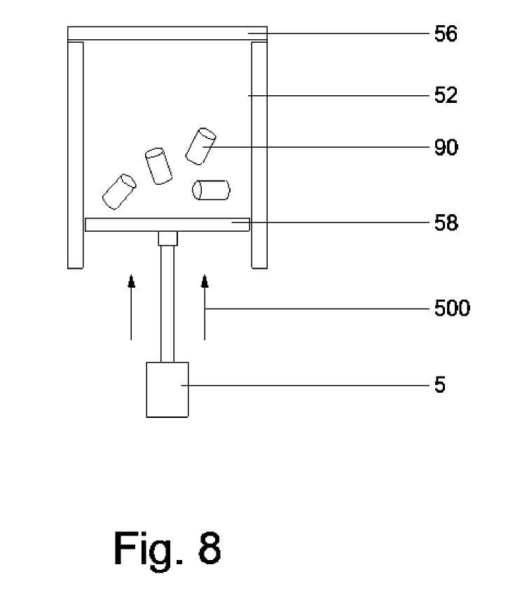

### DETAILED DESCRIPTION

The following description is demonstrative in nature and is not intended to limit the scope of the invention or its application of uses.

There are a number of significant design features and improvements incorporated within the invention.

The device is a can crusher device that can reduce the size of paper, cans (both steel & aluminum) and compost.

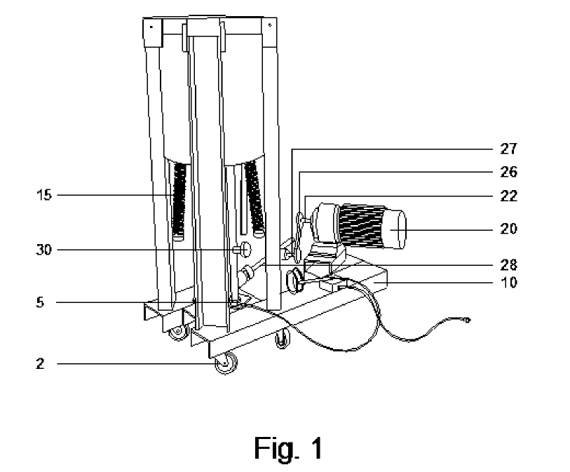

The device 1, as shown in FIG. 1, is capable of crushing paper and aluminum and steel cans. The device 1 is assembled using the following components: hydraulic bottle jack 5, extension springs 15, single-phase geared motor 20, sliding contact mechanism 25, and pressure gauge 30.

The input system of the device 1 consists of two major parts, the driving system 100 and the sliding contact mechanism 200.

The driving system 100 is an electric motor 20 with a gearbox 22. This geared motor 20 is single-phased so it can be utilized in residences and restaurants.

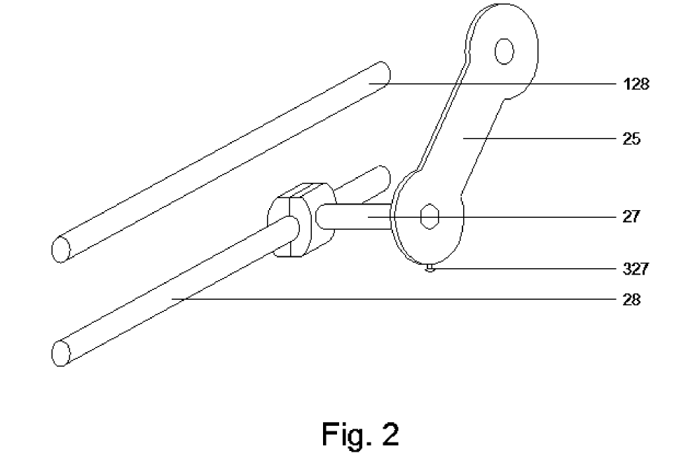

The sliding contact mechanism 25, as shown in FIG. 2, is divided into three main parts: the crank 26, slider 27 and lever 28. The crank 26 is a short link with two holes at both ends; one end is connected to the motor shaft of the mote and the other is connected to the slider 27 by a pin 327. There is a radial ball bearing holder that is welded at the sides of the pin hole in the short link where the two centers of the pin and radial bearing holder are at the same point. An axial ball bearing holder is used with the radial ball bearing holder to hold the ball bearing in place. The crank 26 turns by strokes of the motor 20 which sliders the slider 27 back and forth on the lever 28 in an up and down motion moving lever 28 up and down which drives the pump 5.

The lever 28 is a long cylinder made of a durable strong material like steel and is connected to the jack 5. It is long enough to accommodate the slider path and is of a proper diameter to withstand the bending stress placed by the jack 5 on the lever 28.

In the preferred embodiment, the hydraulic jack 5 is a lifting device that uses liquid-oil to raise heavy objects, but in this case its objective is to crush the cans while being raised. In the preferred embodiment, the jack 5 will have two levers 28 and 128, one for providing short strokes and another for providing larger strokes. The larger strokes enable the crushing process to be accomplished in a shorter period of time. The motor 20 is used to drive the jack 5.

A pressure gauge 30 is connected to the jack 5. This will allow the reading of the load generated in the jack 5 and is used to know if an unsafe amount of force is applied to the load.

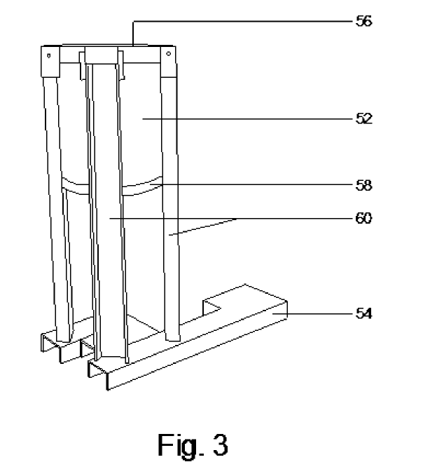

The frame 50, as shown in FIG. 3, is divided into four main parts: container 52, vertical frame 54, upper plate 56 and lower plate 58.

There are four long beams 60 fixed vertically; they are welded onto the base 10 and the side of the container 52. These dimensions have been chosen to withstand the bending force and the stresses.

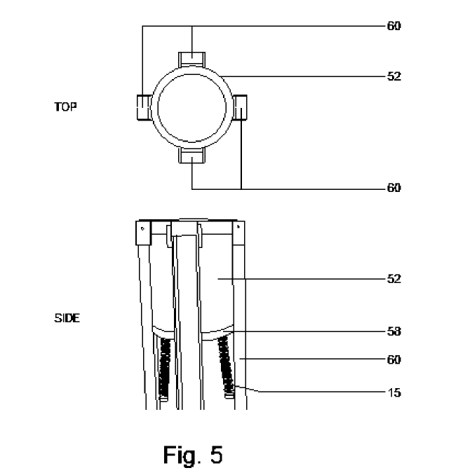

The Container 52, as shown in FIG. 5, has the shape of a thin hollow pipe. The container 52 holds the cans 90 or other material that is to be crushed. The container 52 has a 405 mm inner diameter in the preferred embodiment. The container 52 is open at the top and bottom allowing the upper plate cover 56 and the lower plate 58 to fix in these openings to crush the cans 90. Four vertical beams 60 are welded to it to produce strong structure integrity. The thickness of the container 52 is 4 mm to withstand the heat of welding.

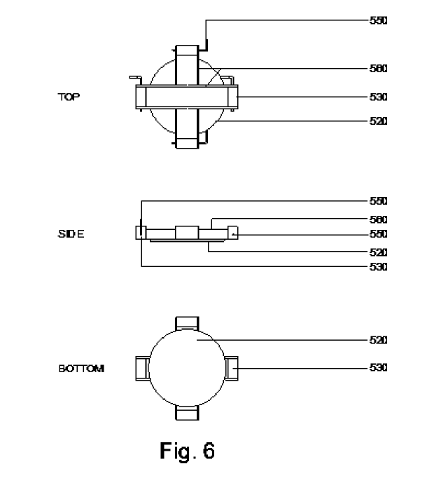

The upper plate cover 56, as shown in FIG. 6, connects to both the container 52 and the beams 60 so that the cans 90 can be compressed against it. The upper plate cover 56 is a circular plate that has a diameter of 395 mm and is 4 mm thick in the preferred embodiment. It consists of four pats, a circular plate 520, U beams 560, square blocks 530 and pins 550. The U beams 560 are welded on the circular plate 520 to assist in withstanding the bending force which is generated from crushing the cans or other material. The blocks 530 are used to connect the upper plate cover 56 with the vertical beams 60. The blocks 530 have a hole 550 in the middle which allows the pin 570 slide through the holes 550 and hold the vertical beams 60 with the upper plate cover 56.

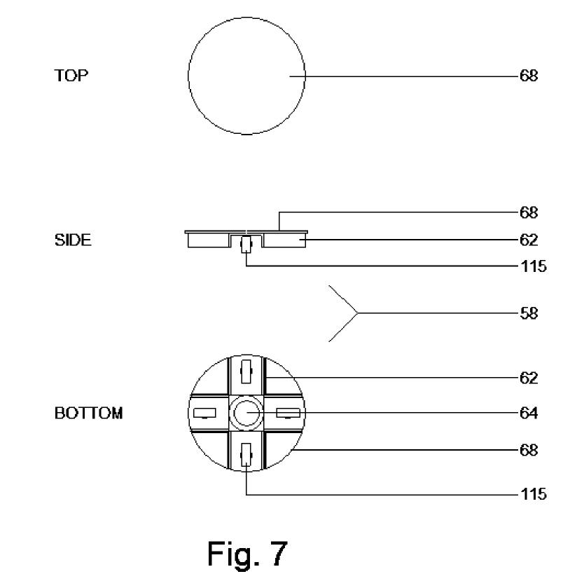

The lower plate 58, as shown in FIG. 7, is connected to the jack 5; the lower plate 58 is made of a number of parts; U beams 62, collar 64 and a circular plate 68. In the preferred embodiment, the circular plate 68 has a diameter of 395 mm and a thickness of 4 mm, the U beams 62 have a length of 150 mm, and the beams 62 help the plate 58 to withstand the bending force which is generated from crushing cans 90. The collar 64 connects the lower plate 58 with the jack 5; it has a cylinder shape with an outer diameter of 80 mm. The beams 62 help the lower plate 58 to withstand the bending force from the crushing force on the can 90 or other crushed material. The collar 64 is a piece that connects the lower plate 58 with the jack 5. It is cylinder in shape and is welded in the middle of the lower plate 58 and is fixed to the jack 5. The lower plate 58 has spring hooks 115 where the extension spring 15 connect to.

The base 10 is designed to hold the frame 50, hydraulic jack 5 and motor 20 together. The beams 60, hydraulic jack 5 and motor 20 are all connected to the base 10. The base 10 is designed in a manner which allows all parts to function freely. The base 10 can be placed on wheels 2 for mobility.

The device 1 uses four extension springs 80 to lower the piston 7 of the hydraulic jack 5 back to its initial position. The extension springs 80 are outside of the container 52 so that they do not interrupt the crushing process of the cans 90 in the container 52.

As shown in FIG. 7, in operation, the motor 20 is used to drive the jack 5 using the gearbox 22. The jack 5 applies force through the sliding contact mechanism 25. The sliding contact mechanism 25 supplies an upward force 500 on the lower plate 58 crushing the cans 90 or other material held in the cylinder against the upper plate cover 56.

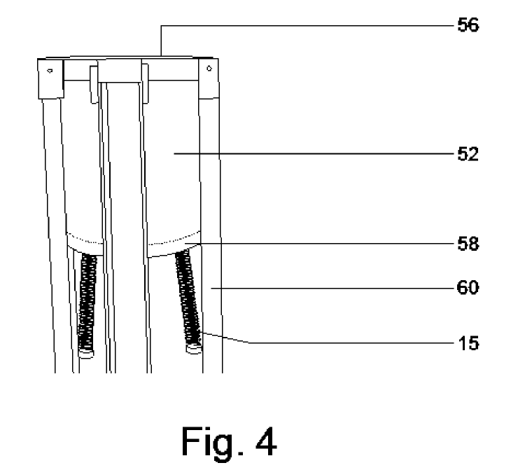

As shown in FIG. 4 the extension springs 15 apply extension force 400 to lower the piston of the hydraulic jack 5 back to its initial position.

When tested, the device 1 fulfils its objectives. Results show that aluminum cans, for instance, are reduced to 95% of their original volume, while steel cans are reduced to around 90%.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A crushing device comprising;
a container, an upper plate connected to said cylinder, a lower plate connected to an input system consisting of a driving system and a sliding contact mechanism, connected to a hydraulic jack, a frame and extension springs where said lower plate applies crushing force against the upper plate.

2. A crushing device according to claim 1, wherein said driving system is a motor.

3. A crushing device according to claim 1, wherein said driving system is a motor and a gearbox attached to said jack.

4. A crushing device according to claim 1, wherein said sliding contact mechanism is made of crank, a slider and a lever.

5. A crushing device according to claim 1, where a pressure gauge is connected to said jack.

6. A crushing device according to claim 1, where said extension spring applies force to return the jack to its initial position.

7. A crushing device according to claim 1, said upper plate is connected to the container by a plurality of blocks.

8. A crushing device according to claim 7, wherein said blocks have a hole in them in which pins are placed to secure the upper plate.

9. A crushing device according to claim 1, wherein said jack has two levers, one for providing short strokes and one for providing large stokes.

10. A crushing device according to claim 1, wherein said jack has two levers, one for providing short strokes and one for providing large stokes.

11. A crushing device according to claim 1, wherein said container, said upper plate and said lower plate are attached to a frame.

12. A crushing device according to claim 1, wherein a plurality of beams is connected to said container and are connected to a base.

13. A crushing device according to claim 1, wherein said container is cylindrical in shape.

14. A crushing device according to claim 1, wherein a plurality of beams is connected to said upper plate.

15. A crushing device according to claim 1, wherein a plurality of beams is connected to said lower plate.

16. A crushing device according to claim 1, wherein a collar connects the lower plate to the jack.

17. A crushing device according to claim 1, wherein the container, the motor and the jack is attached to a base.

18. A crushing device according to claim 17, wherein a plurality of beams is connected to said container and are connected to a base.

19. A crushing device according to claim 1, which is used to crush steel cans.

20. A crushing device according to claim 1, which is used to crush aluminum cans.
